(19) United States
(12) Patent Application Publication
(10) Pub. No.: US 2003/0120679 A1
(43) Pub. Date: Jun. 26, 2003

(54) Method for creating a database index for a piece of music and for retrieval of piece of music

(75) Inventors: Werner Kriechbaum, Ammerbuch-Breitenholz (DE); Gerhard Stenzel, Herrenberg (DE)

Correspondence Address: John L. Rogitz, Rogitz & Associates, 750 B Street, Suite 3120, San Diego, CA, 92101, US

(73) Assignee: International Business Machines Corporation, Armonk, NY (US)

(21) Appl. No.: 10/272,638

(22) Filed: Oct. 16, 2002

(30) Foreign Application Priority Data
Dec. 20, 2001 (DE) 01130396.3

(51) Int. Cl. G06F 7/00

(52) U.S. Cl. 707/102

(57) ABSTRACT

A method for creating a database index and for storing of a piece of music in a database includes extracting at least one property of the piece of music from a digital score of the piece of music, and creating the database index for the piece of music using the property.

### I. FIELD OF THE INVENTION

This invention generally relates to improvements in database applications and internet search engines, and more particularly to provide means for finding pieces of music that sound similar to a given piece of music, or that sound similar to a user selected class of music.

### II. BACKGROUND OF THE INVENTION

The rapid increase in speed and capacity of computers and networks has allowed the inclusion of audio as a data type in many modern computer applications. However, the audio is usually treated as an opaque collection of bytes with only the most primitive database fields attached: name, file format, sampling rate and so on. Users who are accustomed to searching, scanning and retrieving text data can be frustrated by the inability to look inside to audio object.

For example, multimedia databases or file systems can easily have thousands of audio recordings. Such libraries often are poorly indexed or named to begin with. Even if a previous user has assigned keywords or indices to the data, theses are often highly subjective and may be useless to another person. To search for a particular sound or class of sound (e.g., applause or music or the speech of a particular speaker) can be a daunting task.

As an even more ubiquitous example, consider Internet search engines, which index millions of files on the World Wide Web. Existing search engines index search for sounds on the Web in a simplistic manner, based only on the words in the surrounding text on the Web page, or in some cases also based on the primitive fields mentioned above (soundfile name, format, etc.). There is a need for searching based on the content of the sounds themselves.

An example for such a simplistic internet search platform is www.hifind.com of HIFIND Systems AG. This website allows to enter the name of an artist, the title of a song and a title of a CD as a search profile. It also allows to search for similar pieces of music which are closely matching the user provided search criteria.

U.S. Pat. No. 5,918,223 shows a system that performs analysis and comparison of audio data files based upon the content of the data files.

The analysis of the audio data produces a set of numeric values (a feature vector) that can be used to classify and rank the similarity between individual audio files typically stored in a multimedia database or on the World Wide Web. The analysis also facilitates the description of user-defined classes of audio files, based on an analysis of a set of audio files that are members of a user-defined class.

The system can find sounds within a longer sound, allowing an audio recording to be automatically segmented into a series of shorter audio segments.

This system uses a realization, i.e. a recording of an audio data file in order to perform the analysis rather than a representation, i.e. the score.

From IEEE Multimedia, Volume 3, No. 3, fall 1996, pp. 27-36, “Content based classification, search and retrieval of audio” a method for analyzing of acoustical features of music is known for analyzing features such as loudness, pitch, brightness, bandwidth and harmony. For example the pitch is estimated by taking a series of short-time Fourier spectra. For each of these frames, the frequencies and amplitudes of the peaks are measured and an approximate greatest common divisor algorithm is used to calculate an estimate of the pitch. The pitch is stored as a log frequency. The pitch algorithm also returns a pitch confidence value that can be used to weight to pitch in later calculations.

One of the disadvantages of this prior art approach is that the acoustical features of a realization of a given piece of music are dependent on the interpretation of the music by an artist, the instrument, the recording and other acoustical parameters, such that the classification result is also dependent on such external circumstances other than the piece of music itself.

From Wilhelm Fucks, Mathematische Analyse von Formalstrukturen von Werken der Musik, in: Arbeitsgemeinschaft f_r Forschung des Landes Nordrhein-Westfalen, Natur-, Ingenieur- und Gesellschaftswissenschaften, Heft 124, Westdeutscher Verlag, K″ ln und Opladen 1958 it is known to apply a statistical analysis to scores for classification of music. This study provides evidence that the moments of the pitch and interval distribution of a piece of music are related to the year of composition and can be used as an indicator of musical style.

### SUMMARY OF THE INVENTION

The present invention provides for an improved method for creating a database index, for retrieval of pieces of music and for a corresponding computer program product and a data server computer comprising a database.

It is a particular advantage of the present invention that the score of a piece of music is utilized for the classification of the music rather than a realization of the music. Scores are available in digital format such as in MIDI files, in formats like MPEG4 SAOL, or in numerous proprietary score type setting formats like e.g. capella (www.whc.de). By means of such formats a representation of the music is encoded which is representative of the score of the piece of music. The rendering of the music is produced by a client running on the customers audio equipment.

The MIDI standard is described in the “Complete MIDI 1.0 Detailed Specification”, MIDI Manufactures Association, March 1996. A MIDI file contains a number of MIDI sound modules within the data structure as specified in the above-referenced MIDI 1.0 Specification. The ordering of the sound modules within the MIDI file has no impact on the rendering of the file by an instrument, such as a synthesizer, having a MIDI interface. Thus a MIDI file contains a digital score of a piece of music.

Usage of the digital score of a piece of music rather than a representation of the music for indexing the music has the advantage that the findings of the above referenced study by Fucks can be utilized to determine the musical style. This way it is possible to index music independently from the kind of interpretation of a given piece of music by an artist or orchestra.

For example, the representation of a given piece of music by a piano player produces an audio file which has sound properties which are drastically different to an audio file produced by a realization of the same piece of music by means of another instrument. This problem is solved by the means of the present invention as not the artist and instrument dependent realization of the music serves as a basis for the indexing but the score itself.

### BRIEF DESCRIPTION OF THE DRAWINGS

In the following the invention will be described in greater detail by making reference to the drawings in which:

FIG. 1 is illustrative of a method for creating a database index for a piece of music in accordance with the invention,

FIG. 2 is illustrative of a method for retrieval of a similar piece of music from the database,

FIG. 3 is a block diagram of a computer system comprising a database server computer for indexing and retrieval of music.

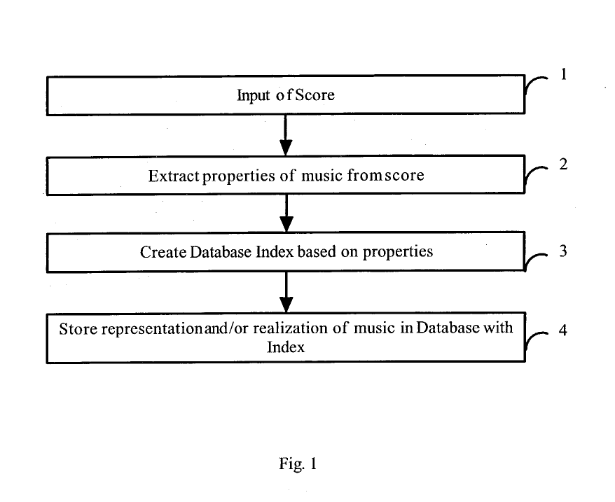

FIG. 1 shows a flowchart of a method for creating a database index for a piece of music. In step 1 a digital score of a piece of music is input into a computer system. For example, this can be done by the inputting of a MIDI file of the piece of music.

In step 2 properties of the piece of music are extracted from the score. This can be done by identifying data of the MIDI file which explicitly represent properties of the piece of music such as its tonality or other properties.

In addition or alternatively, such properties can be extracted by performing a statistical analysis. In order to perform such a statistical analysis, in a first step the pitch information which is provided by the digital score can be encoded numerically. This can be done by mapping the pitch values onto a logarithmic scale that preserves interval relationships. In other words, a numerical value is assigned to each pitch value of each voice contained in the digital score such that a linear scale for the pitch intervals results.

For example, if the pitch information of one of the voices is given by a sequences of tones “C D E F G A H c . . . ” this sequence can be encoded by the following sequence of numerical values “1, 3, 5, 6, 8, 10, 12, 13, . . . ”. This way a linear scale results, because the difference of numerical values of neighboring tones is always the same irrespective of the octave. For example, the difference of the numerical values between an “e” and a “d” is always equal to two; the difference of the numerical values of the same tone in neighboring octaves is always twelve.

This way, a sequence of numerical values is obtained for each voice of the digital score. Such a sequence of numerical values having a linear scale is directly provided by a music file in a MIDI format such that this step does not need to be performed if MIDI is utilized as a file format.

In the next step the first four moments are calculated for each sequence of numerical values. This includes a calculation of the average value, the standard deviation, the skewness, and the kurtosis of the sequence of numerical values. These statistical properties represent properties of the piece of music.

The uncorrected rth moment μᵣ′ of a set of random variables X is defined as μᵣ′(X)=E[X^{r}} where E[X] denotes the expected value. The first uncorrected moment is also known as mean and often written simply as μ.

The rth central moment μᵣ of a set of random variables X is defined as μᵣ(X)=E[(X−E[X])^{r}]

The first central moment is always zero, and the second central moment is commonly known under the name of variance.

It is to be understood that (with the exception of μ₁) central moments can be computed from uncorrected moments and vice versa.

Moment ratios a are derived from the moments by αᵣ(X)=μᵣ(μ₂)^{-r/2}.

The moment ratio α₃ is referred to as “skewness” and the moment ratio α₄ is referred to as “kurtosis”. Both moment ratios describe the shape of the distribution of a set of random variables X.

These and/or other statistical values are determined with respect to the numerical pitch values and serve to index the piece of music to be stored in a database.

In addition the cumulated densities for each sequence of numerical values provided by the voices of the piece of music are determined. This way sequences of cumulated density values result. The cumulated density values can also serve—in addition or alternatively—as properties of the piece of music for indexation purposes.

In a further optional step the statistical moments are averaged over the voices. Alternatively the pitch values of different voices can be cumulated or concatenated prior to the statistical analysis. If averages are used at all and if so, to which extent, is a design choice depending on the amount of available storage space, processing power and processing time.

Rather than performing the above described statistical analysis steps on the numerical values and the sequences of the numerical values of the individual voices it is also an option to determine the differential sequence of the numerical values and to perform the statistical analysis on the differential sequence. The differential sequence is a representation of the pitch intervals. This way additional properties of the piece of music are obtained.

The differential sequence is obtained by computing the differences of the numerical values of the successive notes of a voice. In the example considered above this sequence is “2, 2, 1, 2, 2” as the difference of the numerical values of two notes which are a halftone step apart is always equal to one.

In step 3 a database index is created based on the properties extracted from the digital score. This can be done by using the results of the above described statistical analysis, such as by utilizing the first four moments of the numerical values, i.e. the pitch information, or the differential numerical values, i.e. the pitch interval information. Further the averaged centered moments can be used and/or the cumulated density sequence values. This way an index results consisting of one or more numerical values being representative of a property of the piece of music.

In step 4 a representation and/or a realization of the music or a reference, such as a hyperlink, to a representation and/or realization is stored in a database in conjunction with the index for later retrieval.

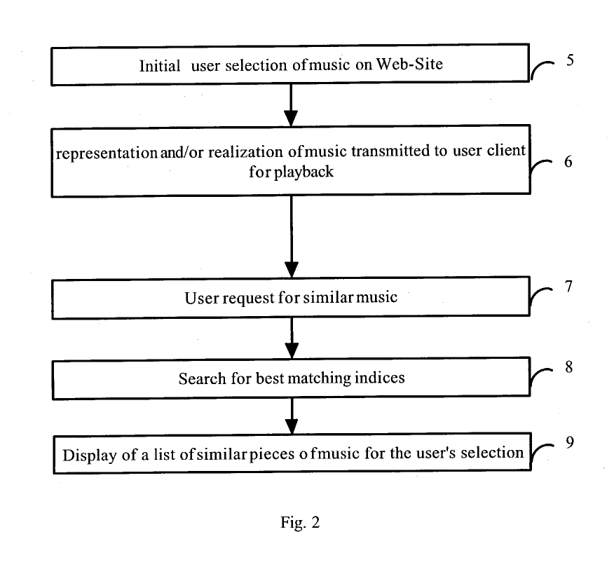

FIG. 2 shows a flowchart for retrieval of similar pieces of music. In step 5 a user makes a initial selection of a piece of music on a website. This piece of music is transmitted to the client computer of the user from the server computer of the website for playback. The transmission can be performed by means of a realization of the piece of music such as by a WAVE, AIFF, real audio or other file format. Alternatively the piece of music can also be transmitted by means of a representation, such as in the form of a MIDI or MPEG-4 SAOL file.

In step 7 the user requests similar music from the website. In response to this request a database search starts in step 8. In a first step the index of the piece of music which has been initially selected by the user in step 5 is determined.

The content of this index is representative of properties of the user selected piece of music in accordance with the method as described in detail with respect to the embodiment of FIG. 1. In a second step the music database index is searched for best matching indices. Best matching indices can be found, for example, by using an optionally weighted Euclidean distance for the difference between the moments and a Kolmogoroff-Smirnov distance for the difference between cumulated interval densities (cf. Nr. Robert R. Sokal/F. James Rohlf, Biometry, Freeman, San Francisco(superscript: 2), 1981).

In step 9 the search results are transmitted to the client computer of the user and are displayed. This way a list of similar pieces of music is provided from which the user can select one or more pieces of music for download from the server computer.

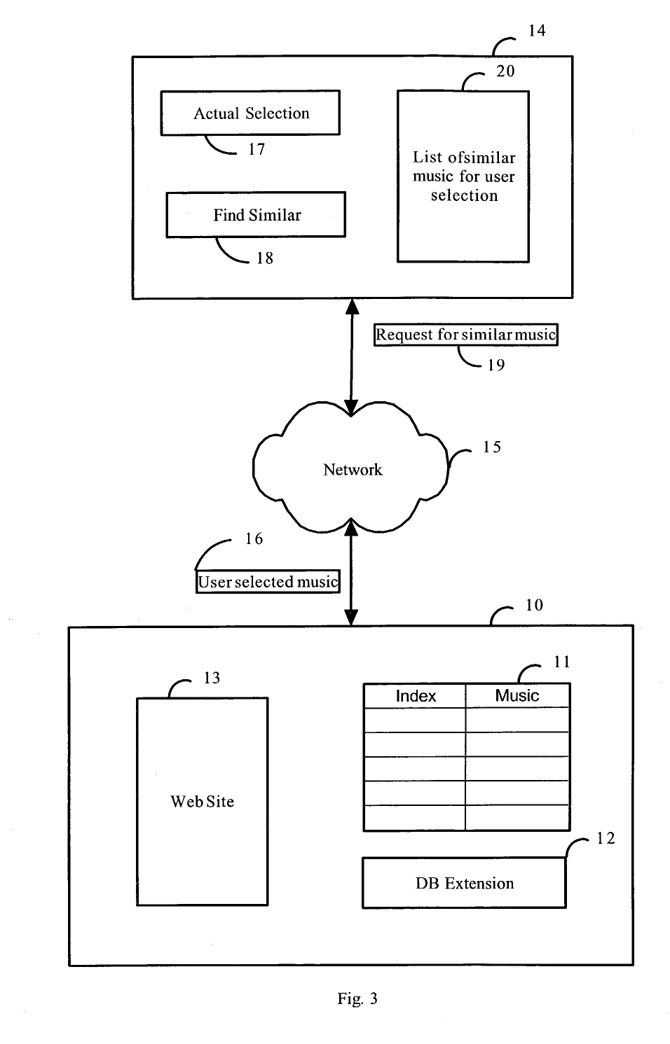

FIG. 3 shows a database server computer 10 having a database 11. The database 11 contains data files of pieces of music. Each data file has an associated index which has been created in accordance with a method as explained with respect to FIG. 1. In other words the index of each piece of music is indicative of properties of the piece of music which are featured by the score.

The database server computer 10 can have a database extension 12 which is an extension of the database system to provide for the indexing of the digital scores of the pieces of music to be stored in the database 11.

Further the database server computer 10 can have a website 13 which is a platform for selecting and downloading of pieces of music. A user of a client computer 14 can access the website 13 via a network 15.

On the website 13 the user of the client computer 14 can select pieces of music by means of the browser program installed on the client computer 14. When the user of the client computer 14 selects a particular piece of music a corresponding file 16 is transmitted from the database server computer 10 over the network 15 to the client computer 14 for playback. This selection of the user is displayed by means of the browser by a graphical element 17 which indicates the actual selection of a piece of music.

When the user is satisfied with his or her selection he or she may want to listen to similar pieces of music. In order to request proposals for similar pieces of music the user selects the graphical element 18 of the website 13 which is displayed by the browser.

In response a request 19 is transmitted from the client computer 14 over the network 15 to the database server computer 10. This request is input into the database extension 12. The database extension 12 determines the index of the piece of music which has been initially selected by the user.

The contents of this index serves as a basis for the search for similar pieces of music in the database 11. The database extension 12 identifies similar pieces of music by searching for best matching indices (cf. step 8 of FIG. 2).

The result of the search is transmitted from the database server computer 10 over the network 15 to the client computer 14 and is displayed in box 20 by the browser program. As a result the box 20 contains a list of similar music for the user's selection. This can be done by providing a list of hyperlinks to the corresponding files of the pieces of music of database 11.

It is to be noted that the music files themselves do not necessarily need to be stored within database 11 but that pointers such as a hyperlinks can be stored within the database 11 instead. Such pointers or hyperlinks can point to files stored on the database server computer 10 or to other server computers of the network 15, i.e. the internet.

We claim:

1. A method for creating a database index for a piece of music, comprising:
extracting at least one property of the piece of music from a digital score of the piece of music; and
creating the database index for the piece of music using the at least one property.

2. The method of claim 1 further comprising assigning a numerical value to each pitch value of each of a plurality of voices in the digital score of the piece of music such that a linear scale for plural pitch intervals results.

3. The method of claim 2, further comprising performing a statistical analysis of the numerical values.

4. The method of claim 3, further comprising averaging the numerical values over the pitch values.

5. The method of claim 4, further comprising determining a standard deviation and/or higher statistical moments of the numerical values and/or determining a cumulated density of the numerical values and/or characterizing a shape of a distribution of pitches for each voice or of the averaged numerical values.

6. The method of claim 2, further comprising:
determining a sequence of pitch values for each voice;
performing a statistical analysis of the pitch values.

7. The method of claim 1 further comprising storing the piece of music in conjunction with the database index, the database index comprising one or more results of at least one statistical analysis.

8. A method for retrieval of a piece of music from a database having a database index for each piece of music stored in the database, comprising:
selecting a first piece of music;
finding one or more similar pieces of music by searching best matches for an index of the first piece of music in the database; and
selecting a second piece of music from the similar pieces of music.

9. The method of claim 8, wherein the best match is determined by a weighted distance between moments and/or moment ratios.

10. The method of claim 8, wherein the best match is determined by a distance between densities or cumulated densities.

11. A computer program product, comprising:
means for extracting at least one property of the piece of music from a digital score of the piece of music; and
means for creating the database index for the piece of music using the at least one property.

12. The computer program product of claim 11, further comprising means for assigning a numerical value to each pitch value of each of a plurality of voices in the digital score of the piece of music such that a linear scale for plural pitch intervals results.

13. The computer program product of claim 12, further comprising means for performing a statistical analysis of the numerical values.

14. The computer program product of claim 13, further comprising means for averaging the numerical values over the pitch values.

15. The computer program product of claim 14, further comprising means for determining a standard deviation and/or higher statistical moments of the numerical values and/or determining a cumulated density of the numerical values and/or characterizing a shape of a distribution of pitches for each voice or of the averaged numerical values.

16. The computer program product of claim 12, further comprising:
means for determining a sequence of pitch values for each voice; and
means for performing a statistical analysis of the pitch values.

17. A database server computer, comprising logic for executing method acts comprising:
extracting at least one property of the piece of music from a digital score of the piece of music; and
creating the database index for the piece of music using the at least one property.

18. The database server computer of claim 17, wherein the method acts further comprise assigning a numerical value to each pitch value of each of a plurality of voices in the digital score of the piece of music such that a linear scale for plural pitch intervals results.

19. The database server computer of claim 17, comprising a database extension for creating an index for a piece of music in the database and having a website for inputting a user request and a user selection of a similar piece of music.
